(19) United States
(12) Patent Application Publication
(10) Pub. No.: US 2003/0023697 A1
(43) Pub. Date: Jan. 30, 2003

(54) Electronic mail composing device and electronic mail communication system

(75) Inventor: Kazuhiro Okada, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/202,071

(22) Filed: Jul. 23, 2002

(30) Foreign Application Priority Data
Jul. 25, 2001 (JP) 2001-223928

(51) Int. Cl. G06F 15/16

(52) U.S. Cl. 709/206; 709/203

(57) ABSTRACT

The present invention provides an electronic mail composing device including an editing unit for editing an electronic mail by setting either to attach content of at least one attachment file or to notify only a title of the attachment file. The electronic mail composing device also includes a generating unit for generating the electronic mail with the notified title of the attachment file and a communication unit for transmitting the electronic mail attached with the content of the attachment file or the electronic mail with the notified title generated in the generating unit.

### CROSS REFERENCE TO RELATED APPLICATION

The present application claims priority of Japanese Patent Application No. 2001-223928 filed Jul. 25, 2001 with Japanese Patent Office and the entire disclosure thereof is incorporated herein by reference.

### FIELD OF THE INVENTION

The present invention relates to an electronic mail composing device and an electronic mail communication system wherein an electronic mail is exchanged via a network.

### DESCRIPTION OF THE RELATED ART

Recently, electronic mails have been frequently exchanged via networks. Generally, only text data can be written in the body of the electronic mail messages. Therefore, when transmitting information other than text data, for example, image data, voice data, or program data, the information is attached to the electronic mail as an attachment file and then transmitted.

Moreover, when transmitting an electronic mail to many destinations, the electronic mail address which is the destination, is listed in the address field, CC (carbon copy) field, BBC (blind carbon copy) field or the like. When transmitting the electronic mail by listing the destinations in such a manner, the electronic mail having the same content is received at each destination. Moreover, the attachment file is also received at all listed destinations.

However, there are many cases in which the content of the attachment file is not necessary for each of the destinations. For example, for destinations that require only the record of the exchanging of the electronic mail, the content of the attachment file is unnecessary. For the destination that does not require the content of the attachment file, there are disadvantages for receiving the unnecessary information. For example, a long period of time is taken for the communication, the communication expenses amount up, and the memory capacity for saving the attachment file is necessary. Moreover, the sender of the electronic mail is causing inconvenience to the receiver.

In case there are both the destination which needs the attachment file, and the destination which does not need the attachment file, as one solution, the sender of the electronic mail can compose an electronic mail with the attachment file and compose an electronic mail without the attachment file, and then transmit the electronic mails. However, it is troublesome composing two separate electronic mails having the same content and also, it is troublesome managing the transmitted electronic mails.

### SUMMARY OF THE INVENTION

The present invention was made in consideration to abovementioned circumstance, and it is thus an advantage of the present invention to provide an electronic mail composing device capable of composing an electronic mail easily so that the contents of an attachment file is not sent to a destination not requiring the contents of the attachment file, even in the case, where the electronic mail is composed with the attachment file and sent to many destinations. In addition, it is another advantage of the present invention to provide an electronic mail communication system wherein the receiver of the electronic mail is capable of demanding the content of the attachment file when necessary.

The present invention provides an electronic mail composing device including an editing unit for editing an electronic mail by setting either to attach content of at least one attachment file or to notify only a title of the attachment file. The electronic mail composing device also includes a generating unit for generating the electronic mail with the notified title of the attachment file and a communication unit for transmitting the electronic mail attached with the content of the attachment file or the electronic mail with the notified title generated in the generating unit.

At the other end which received the electronic mail added with the title of the attachment file in the electronic mail, since the unnecessary content of the attachment file is not being forwarded, the time required for forwarding can be shortened and accordingly, the communication expenses and the memory capacity can be saved. In addition, since the title of the attachment file is added, the other end is capable of confirming that the other users, who received the electronic mail of the same content, received the content of the attachment file.

Moreover, the electronic mail communication system according to the present invention includes a first communication device which attaches the content of the attachment file to the electronic mail or adds only the title of the attachment file and then transmits the electronic mail, and a second communication device which receives the electronic mail and when the title of the attachment file is added in the received electronic mail, is capable of transmitting the content of the attachment file of the title to the first communication device. Moreover, when the first communication device receives the transmission demand for the content of the attachment file from the second communication device, the first communication device forwards the content of the attachment file to the second communication device. For example, the second communication device can be constructed to demand the transmission of the content of the attachment file according to the indication from the user to the title of the attachment file in the received electronic mail.

By such electronic mail communication system, to the destination of which the content of the attachment file is unnecessary as in the manner stated above, only the title of the attachment file can be transmitted. Moreover, when receiving the electronic mail added with the title of the attachment file, in the case the content of the attachment file is necessary, the transmission of the content of the attachment file can be demanded to the transmitting side and the content of the attachment file can be obtained.

### BRIEF DESCRIPTION OF THE DRAWINGS

FIG. 1 is a block diagram showing an embodiment of the electronic mail communication system of the present invention including an example of the electronic mail composing device of the present invention.

FIG. 2 is a flow chart showing an example of the operation according to an embodiment of the electronic mail composing device of the present invention.

FIG. 3 is a view useful for explaining an example of the electronic mail edited by the electronic mail editing unit 12.

FIG. 4 is a view useful for explaining an example of the electronic mail added with the title of the attachment file to be generated in the electronic mail generating unit 13.

FIG. 5 is a view useful for explaining an example of the electronic mail which the destination is changed in the electronic mail generating unit 13.

FIG. 6 is a view useful for explaining another example of the electronic mail to be generated in the electronic mail generating unit 13.

FIG. 7 is a view useful for explaining an example of the exchanging of the electronic mails according to an embodiment of the electronic mail communication system of the present invention.

### DETAILED DESCRIPTION OF THE PREFERRED EMBODIMENTS

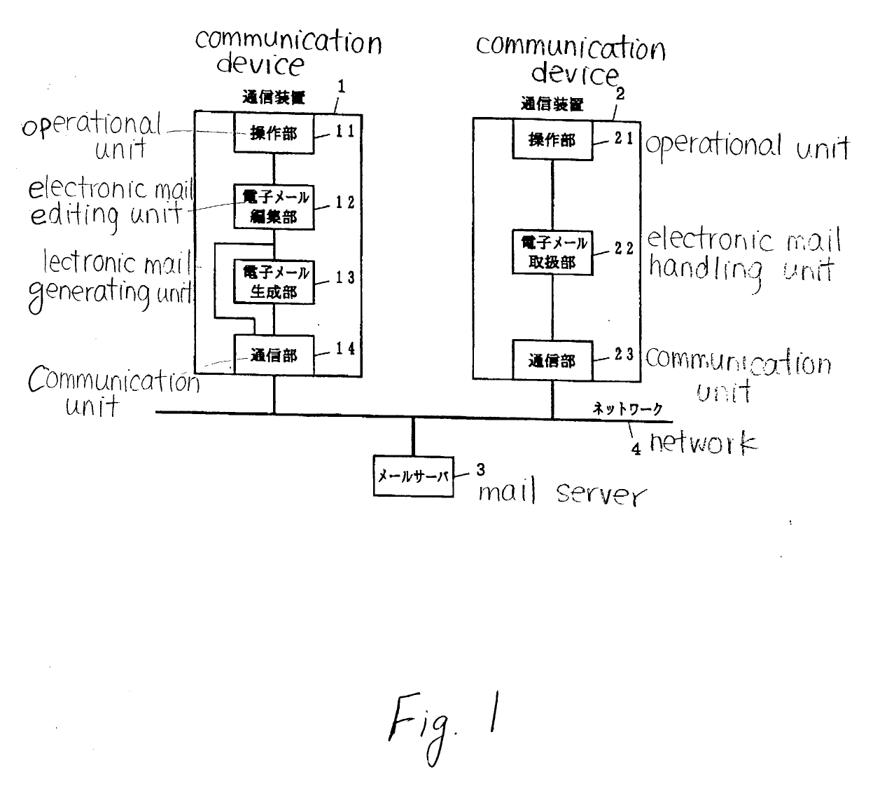

FIG. 1 is a block diagram showing an embodiment of the electronic mail communication system of the present invention including an example of the electronic mail composing device of the present invention. In FIG. 1, 1 and 2 are communication devices, 3 is a mail server, 4 is a network, 11 is an operational unit, 12 is an electronic mail editing unit, 13 is an electronic mail generating unit, 14 is a communication unit, 21 is an operational unit, 22 is an electronic mail handling unit, and 23 is a communication unit. In the example shown in FIG. 1, the communication device 1, the communication device 2, and the mail server 3 are capable of carrying out a communication via the network 4. The network 4 connects each device by various connection forms, such as LAN (Local Area Network) or the Internet. Moreover, various other network apparatus can be connected to the network 4.

The communication device 1 includes an example of the electronic mail composing device of the present invention. The electronic mail composing device functions as the transmitter of the electronic mail. The communication device 2 is the recipient of the electronic mail. Generally, the electronic mail is forwarded to the mail server 3 which is provided in a domain included with a destination, and then the electronic mail is forwarded to the recipient by the recipient accessing the mail server 3. Although, the communication device 1 is receiver of the electronic mail, devices are capable of transmitting and receiving electronic mail.

The communication device 1 is provided with the operational unit 11, the electronic mail editing unit 12, the electronic mail generating unit 13, and the communication unit 14. The operational unit 11 is constructed with an inputting means, a displaying means or the like and is a section where the user carries out the operation to the communication device 1.

The electronic mail editing unit 12 carries out the editing of the electronic mail following the indication from the operational unit 11. For the editing of the electronic mail, for example, the editing of the content or the heading, and the designation of the attachment file or the designation of the destination can be carried out. When attaching the attachment file, it can be set to which destination the content of the attachment file is to be transmitted and to which destination only the title of the attachment file is to be transmitted, per each file to be attached, or per each destination. Then, when receiving the indication of the transmission from the operational unit 11, the edited electronic mail is passed to the electronic mail generating unit 13 and the communication unit 14.

When a setting is made to transmit only the title of the file attached to the electronic mail edited in the electronic mail editing unit 12, the electronic mail generating unit 13 generates a new electronic mail including the title of the attachment file. Further, in the case a different attachment file is to be attached according to the destination, depending on the pattern of whether or not to attach each attachment file, a new electronic mail corresponding to each destination can be generated. Moreover, concerning the original electronic mail edited at the electronic mail editing unit 12, changes can be made to the destination field, CC field or the like.

Furthermore, the electronic mail generating unit 13 generates the electronic mail including the title of the attachment file, and after transmitting from the communication unit 14, accepts the forwarding demand of the content of the attachment file from the destination of the electronic mail. When receiving the forwarding demand, a new electronic mail attached with the demanded attachment file is composed, and the electronic mail is passed to the communication unit 14.

The communication unit 14 carries out the communication with other network apparatus via the network 4. In particular, when transmitting the electronic mail, for the destination to which all the attachment files are to be transmitted, when there is no other changing processing or the like, the electronic mail edited in the electronic mail editing unit 12 is transmitted. Moreover, concerning the attachment file, in the case changes are made by the electronic mail generating unit 13 to the destination, the destination field, CC field or the like which are to be transmitted only with the tile, the electronic mail generated in the electronic mail generating unit 13 is to be transmitted. The transmitted electronic mail is forwarded to the mail server 3 for example and stored. Further, when receiving the forwarding demand of the attachment file from the destination of the electronic mail, the forwarding demand is passed to the electronic mail generating unit 13, and the electronic mail corresponding to the forwarding demand passed from the electronic mail generating unit 13 is also transmitted.

On the other hand, the communication device 2 is provided with the operational unit 21, the electronic mail handling unit 22, the communication unit 23 or the like. The operational unit 21 is formed with the inputting means, the displaying means or the like, and is the section where the user carries out the operation to the communication device 2. In particular, in the case of displaying the received electronic mail by the displaying means or the title of the attachment file is included in the displayed electronic mail, the forwarding of the content of the attachment file can be indicated from the inputting means.

The electronic mail handling unit 22 provides various functions concerning the electronic mail, obtains the electronic mail addressed to the user via the communication unit 23 following the indication from the operational unit 21, and the obtained electronic mail is displayed on the displaying device of the operational unit 21. Moreover, when the title of the attachment file is included in the obtained electronic mail, in the case the forwarding of the content of the attachment file is indicated, the forwarding demand is sent to the transmitter of the electronic mail via the communication unit 23. In addition, the electronic mail handling unit 22 obtains the content of the attachment file being sent in accordance with the forwarding demand and provides the content to the user.

The communication unit 23 carries out the communication with other network apparatus via the network 4. In particular, when receiving the electronic mail, the communication unit 23 demands to obtain the electronic mail addressed to the user to the mail server 3, and the electronic mail being sent is received. Moreover, in the case the forwarding demand for the content of the attachment file generates from the electronic mail handling unit 22, the communication unit 23 transmits the forwarding demand. Furthermore, the communication unit 23 carries out the receiving of the content of the attachment file being sent in accordance with the forwarding demand. Further, the forwarding demand of the content of the attachment file or the receiving of the content of the attachment file corresponding to the former can be carried out by the electronic mail.

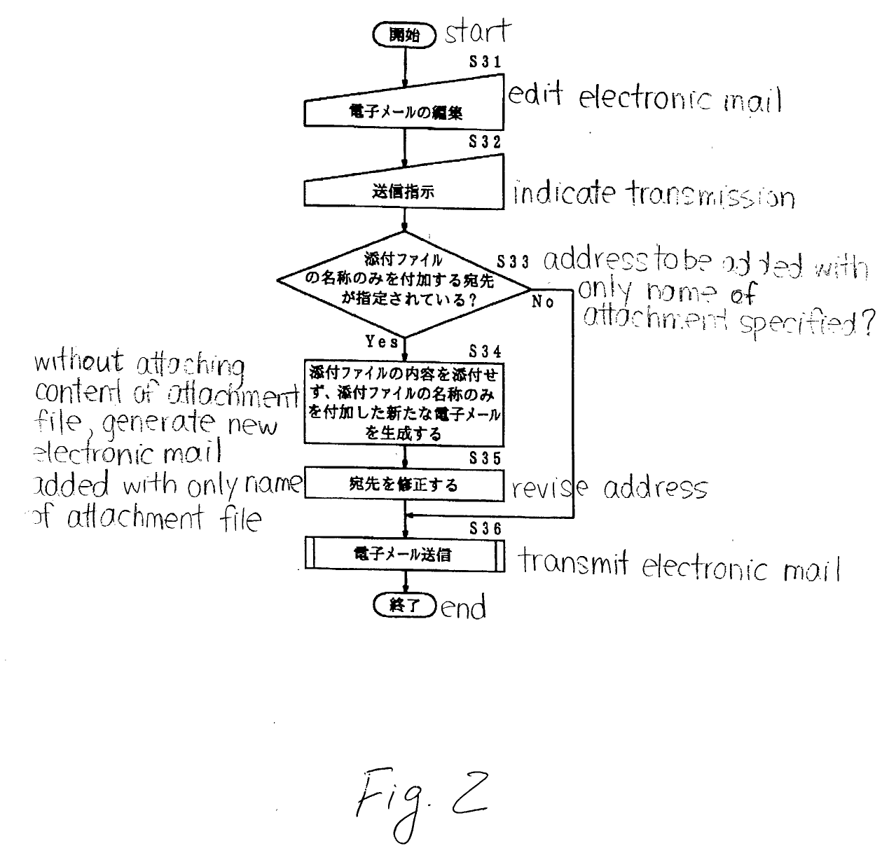

Next, it will be described of an example of the operation in the electronic mail composing device and the electronic mail communication system of the present invention. FIG. 2 is a flow chart showing an example of the operation according to an embodiment of the electronic mail composing device of the present invention. It is shown of a processing from the formation of the electronic mail in the communication device 1 to transmission. In S31, the user of the communication device 1 inputs the destination or the content and designates the attachment file by using the operational unit 11, and further, concerning the attachment file, the user of the communication device 1 carries out by using the electronic mail editing unit 12, the setting whether to transmit the content or to transmit only the title.

When the editing of the electronic mail is completed, in S32, the user indicates the transmission of the electronic mail from the operational unit 11. According to the indication, in S33, the electronic mail editing unit 12 judges whether or not there is the destination to be added only the title of the attachment file. When the destination for attaching only the title of the attachment file is not present, the normal electronic mail transmission is to be carried out. Therefore, the edited electronic mail is sent to the communication unit 14 and in S36, the electronic mail is transmitted from the communication unit 14. Moreover, when there is the destination for adding only the title of the attachment file, the edited electronic mail is sent to the electronic mail generating unit 13 and the communication unit 14.

When the electronic mail generating unit 13 receives the electronic mail from the electronic mail editing unit 12, in S34, concerning the attachment file of which only the title is to be added, instead of setting to attach the attachment file, a new electronic mail is to be generated, added with the title of the attachment file in the electronic mail, for example, in the main text. Furthermore, in S35, changes are made to the destination for the electronic mail received from the electronic mail editing unit 12 and the newly generated electronic mail. Then, in S36, these electronic mails are transmitted from the communication unit 14.

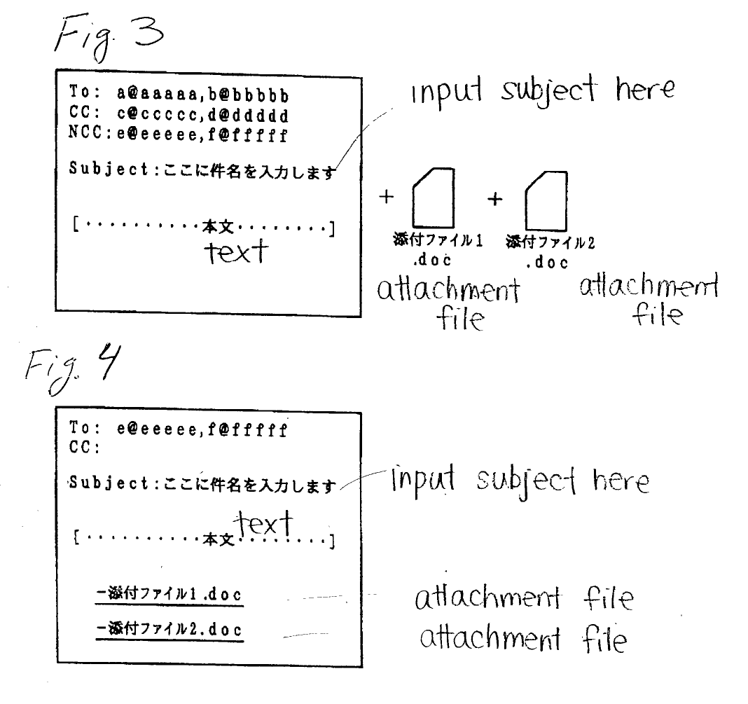

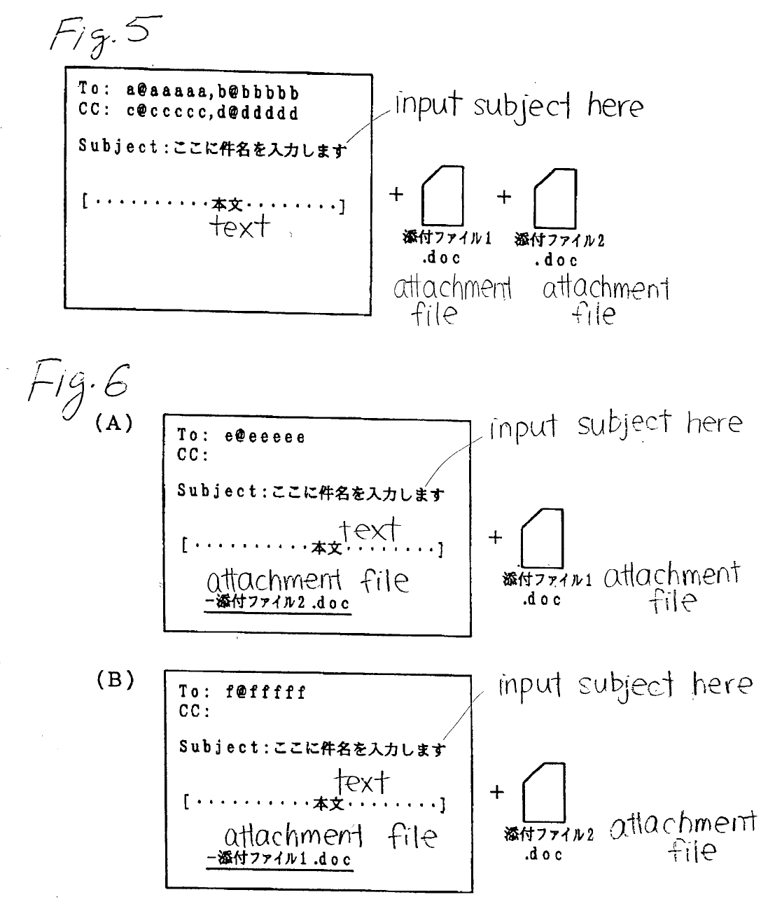

An example of abovementioned operation will now be described by referring to a specific example. FIG. 3 is a view useful for explaining an example of the electronic mail edited by the electronic mail editing unit 12, and FIG. 4 and FIG. 5 are views useful for explaining an example of the electronic mail to be generated by the electronic mail generating unit 13. As an example, it is shown of a case in which setting is made per each destination, whether to attach the content for all of the attachment files or whether to attach only the title. Since the setting is made for the attachment file, whether to attach the content or whether to add only the title, apart from for example, To field where the destination is to be written, CC field where the destination of which to be transmitted with a copy is to be written, and BCC field where the fact that the electronic mail is transmitted is hidden from other destinations, NCC field is provided for notifying only the title concerning the attachment file. By writing the destination in NCC field, the content of the attachment file is not sent to the electronic mail addressed to the destination, and the electronic mail added with the title of the attachment file is sent.

For example, in the example shown in FIG. 3, it is assumed that it is set for “attachment file 1.doc” and “attachment file 2.doc” to be attached and transmitted as the attachment files. Moreover, for the destination in To field, “a@aaaaa” and “b@bbbbb” are set, and for the destination in CC field, “c@ccccc” and “d@ddddd” are set. Furthermore, for the destination in NCC field, “e@eeeee” and “f@fffff” are set and it is set to notify only the title of two attachment files to the destination “e@eeeee” and “f@fffff”.

Further, the field name “NCC field” used in FIG. 3 is an example, and it can be of other field name. Moreover, apart from preparing such separate field, any methods can be used, for example, to set to notify only the title of the attachment file by adding a specific mark or the like to To field or CC field, or to display a dialog which sets separately whether to transmit the content of the attachment file or whether to notify the title and to set within the dialog.

In the case the electronic mail as shown in FIG. 3 is edited and passed to the electronic mail generating unit 13, as shown in FIG. 4 for example, the electronic mail generating unit 13 generates a new electronic mail added with the title of the attachment file in the main text of the electronic mail. Then, for the destination of the new electronic mail added with the title of the attachment file, “e@eeeee” and “f@fffff” are set. As a result, the attachment file is not forwarded to the destination “e@eeeee” and “f@fffff” and the electronic mail added with the title of the attachment file in the electronic mail is to be received.

Moreover, for other destinations, the attachment file is forwarded as usual. In such case, basically, the electronic mail edited in the electronic mail editing unit 12 is to be transmitted, however, since NCC filed is provided which is not used generally for the destination, this field is to be deleted and then the electronic mail as shown in FIG. 5 is transmitted. Accordingly, the electronic mail attached with the attachment file is to be transmitted to the destination “a@aaaaa”, “b@bbbbb”, “c@ccccc”, and “d@ddddd”. In the transmitted electronic mail, a special field is not provided like NCC field as shown in FIG. 3, and the electronic mail can be received by the normal electronic mail software.

Further, in this example, in the electronic mail added with the title of the attachment file as shown in FIG. 4, the destination which are written in To field and CC field, are to be excluded. Moreover, for the electronic mail to be attached with the attachment file as shown in FIG. 5, the destination written in NCC field is to be excluded. To prevent such exclusion of the destinations, for example, concerning the destination which are to be excluded, To field or CC field, or NCC field can be provided at the head of the main text for example, and the writing of the destination can be added. Moreover, in the case it is known in beforehand that the receiving side is to use an exclusive electronic mail software corresponding to NCC field or the like, without changing the destination field (To field, CC field, NCC field), it can be transmitted as it is.

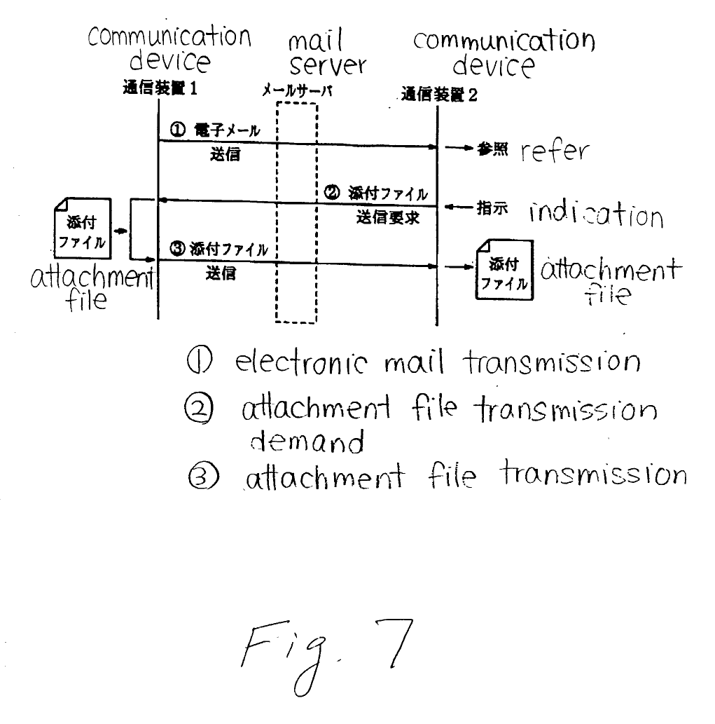

FIG. 6 is a view useful for explaining another example of the electronic mail to be generated by the electronic mail generating unit 13. In the specific example shown in FIG. 3 through FIG. 5, it is shown of a case in which the setting is made by selecting either to attach all the attachment files or to add only the title of all the attachment files. The present invention is not to be limited to this, and for example, it can be constructed to be able to set to which destination the content is to be transmitted and to which destination only the title is to be transmitted, per each attachment file. For example, in the example shown in FIG. 3, it can be constructed to be able to set in the manner, for the “attachment file 1.doc”, the content is to be transmitted to “e@eeeee” and only the title is to be transmitted to “f@fffff”, and for the “attachment file 2.doc”, the content is to be transmitted to “f@fffff”, and only the title is to be transmitted to “e@eeeee”. When carrying out such setting, the electronic mail generating unit 13 generates two new electronic mails as shown in FIG. 6 for example, and such electronic mails are to be transmitted to the destination “e@eeeee” and “f@fffff” respectively.

As in the manner stated above, according to the present invention, to the destination which is not requiring the forwarding of the content of the attachment file, for example, the destination which is preferable to be notified only with the outline of the electronic mail or the record of the exchanging of the electronic mails, by setting at the transmitting side, the electronic mail added with the title of the attachment file can be transmitted. As a result, at the receiving side, the communication is not continued for a long period of time for receiving unnecessary attachment file, the expenses required for the communication can also be saved and the memory capacity for storing the attachment file can also be saved.

However, when transmitting the electronic mail added only with the title of the attachment file according to the judgment at the transmitting side, there are cases in which the receiving side demands to refer to the content of the attachment file. According to the electronic mail communication system of the present invention, in such case, based on the title of the attachment file in the received electronic mail, the forwarding demand for the content of the attachment file can be sent back, and the content of the attachment file can be sent.

FIG. 7 is a view useful for explaining an example of the exchanging of the electronic mails according to an embodiment of the electronic mail communication system of the present invention. It is shown of a case in which the electronic mail is transmitted, added with the title of the attachment file, to the communication device 2 from the communication device 1 shown in FIG. 1. In \mathring{1}, as in the manner described by referring to the flow chart shown in FIG. 2 and the specific examples shown in FIG. 3 through FIG. 6, the communication device 1 transmits the electronic mail added with the title of the attachment file without transmitting the content of the attachment file. The communication device 2 receives the electronic mail via the mail server 3.

The electronic mail received by the communication device 2 is managed in the electronic mail handling unit 22, and for example, the electronic mail is displayed in the displaying device or the like of the operational unit 21, and the user is capable of confirming the content of the electronic mail. For example, the electronic mail attached with the title of the attachment file as shown in FIG. 4 is displayed.

Suppose that the user desires to refer to the content of the attachment file. In such case, for example, the user demands to refer to the content of the attachment file by indicating the title of the attachment file in the electronic mail from the operational unit 21. When receiving such reference demand of the content of the attachment file from the user, in \mathring{2} in FIG. 7, the electronic mail handling unit 22 demands the transmission of the content of the attachment file indicated by the user, to the communication device 1 which is the transmitter of the electronic mail. This demand can be carried out in any method if the method is capable of being judged by the communication device 1. For example, it can be assumed of transmitting the electronic mail including title of the attachment file and the information showing the transmission demand, from the communication unit 23 to the communication device 1. Moreover, for example, in the case of the LAN or the like, by using SNMP or individual protocol, the transmission demand can be transmitted to the communication device 1 directly.

In \mathring{3} in FIG. 7, the communication device 1 which received the transmission demand of the content of the attachment file from the communication device 2, transmits to the communication terminal device 2, the content of the attachment file which is demanded to be transmitted. For example, when the transmission demand of the content of the attachment file is being sent as the electronic mail, the electronic mail is received via the communication unit 14 and by analyzing the content, it is confirmed that the electronic mail is the transmission demand of the content of the attachment file. Moreover, the title or the like of the attachment file which is demanded to be transmitted, is obtained. Then, based on the obtained title of the attachment file, a new electronic mail attached with the content of the attachment file is generated by the electronic mail generating unit 13, and the electronic mail is transmitted to the communication device 2 from the communication unit 14.

As in the manner stated above, in the case only the title of the attachment file is added in the electronic mail and the content is not sent, when it is preferable to refer to the content of the attachment file, the content of the attachment file can be transmitted anew. Conventionally, a hyper link is provided in the electronic mail and by indicating, the content of the file on the Web can be confirmed. However, for example, for the attachment file of the electronic mail, there are many cases in which it is the file put in a private environment, and by the hyper link or the like, the forwarding of the content of the attachment file cannot be received. However, as in the manner stated above, by demanding the forwarding to the destination by electronic mail or other method, even the file under the private environment can receive the forwarding.

Further, in the description above, the content of the attachment file is transmitted automatically in the communication device 1 which received the transmission demand of the content of the attachment file, however, it is not to be limited to such case and for example, the user who indicated the transmission of the original electronic mail can be notified from the indication or the like of the fact that there is the transmission demand of the content of the attachment file and after receiving the transmission confirmation from the user, the content of the attachment file can be transmitted. Accordingly, unlawful access from the outside can be prevented to some extent. Moreover, by applying various methods of the public domain, such as carrying out the certification when demanding the forwarding, the safety can be improved even more.

Moreover, in the description above, the user demanded the transmission of the content of the attachment file in the communication device 2 which received the electronic mail attached with the title of the attachment file, however, the present invention is not to be limited to such case and for example, when the title of the attachment file is added in the electronic mail by a setting, the content of the attachment file can be demanded to be transmitted automatically.

As it is evident from the description above, according to the present invention, it is set at the transmitting side, either to attach the content of the attachment file or to add only the title of the attachment file, and the electronic mail corresponding to the setting can be transmitted to each destination. Accordingly, for the receiving side which does not require the content of the attachment file, the communication is not carried out for a long period of time due to the forwarding of the attachment file, the communication expenses can be saved and the memory capacity for saving the attachment file can also be saved.

Moreover, when receiving the electronic mail added only with the title of the attachment as in the manner stated above, in the case the content of the attachment file is necessary, the content of the attachment file can be obtained by carrying out the transmission demand of the content of the attachment file to the transmitter. Therefore, even when the transmitter thinks that the content of the attachment file is unnecessary, there is an effect in that according to the demand of the receiving side, the content of the attachment file can be transmitted.

What is claimed is:

1. An electronic mail composing device comprising:
an editing means for editing an electronic mail by setting either to attach content of at least one attachment file or to notify only a title of the attachment file;
a generating means for generating the electronic mail with the notified title of the attachment file; and
a communication means for transmitting the electronic mail attached with the content of the attachment file or the electronic mail with the notified title generated in the generating means.

2. The electronic mail composing device according to claim 1, wherein the editing means accepts the setting whether to attach the content for each attachment file or whether to notify only the title of the attachment file for each attachment file, and the generating means generates the electronic mail with the notified title.

3. The electronic mail composing device according to claim 1, wherein the editing means sets a destination for which to attach the attachment file and a destination for which to be notified only with the title of the attachment file, and the communication means transmits according to the destination, the electronic mail attached with the attachment file or the electronic mail generated in the generating means.

4. The electronic mail composing device according to claim 2, wherein the editing means sets a destination for which to attach the attachment file and a destination for which to be notified only with the title of the attachment file, and the communication means transmits according to the destination, the electronic mail attached with the attachment file or the electronic mail generated in the generating means.

5. An electronic mail communication system comprising:
a first communication device which attaches content of an attachment file to an electronic mail or adds only a title of the attachment file to the electronic mail and then transmits the electronic mail; and
a second communication device which receives the electronic mail having the added title to the electronic mail, and demands transmission of the content of the attachment file from the first communication device;
wherein the first communication device forwards the content of the attachment file to the second communication device when receiving the transmission demand of the content of the attachment file from the second communication device.

6. The electronic mail communication system according to claim 5, wherein the second communication device carries out the transmission demand of the content of the attachment file according to the indication from the user to the title of the attachment file in the received electronic mail.

7. An electronic mail composing device comprising:
an editing unit for editing an electronic mail by setting either to attach content of at least one attachment file or to notify only a title of the attachment file;
a generating unit for generating the electronic mail with the notified title of the attachment file; and
a communication unit for transmitting the electronic mail attached with the content of the attachment file or the electronic mail with the notified title generated in the generating unit.

8. The electronic mail composing device according to claim 7, wherein the editing unit accepts the setting whether to attach the content for each attachment file or whether to notify only the title of the attachment file for each attachment file, and the generating unit generates the electronic mail with the notified title.

9. The electronic mail composing device according to claim 7, wherein the editing unit sets a destination for which to attach the attachment file and a destination for which to be notified only with the title of the attachment file, and the communication unit transmits according to the destination, the electronic mail attached with the attachment file or the electronic mail generated in the generating unit.

10. The electronic mail composing device according to claim 8, wherein the editing unit sets a destination for which to attach the attachment file and a destination for which to be notified only with the title of the attachment file, and the communication unit transmits according to the destination, the electronic mail attached with the attachment file or the electronic mail generated in the generating unit.

11. The electronic mail composing device according to claim 1, wherein the editing means places a specific mark in an address field to notify only the title of the attached file.

12. The electronic mail composing device according to claim 7, wherein the editing unit places a specific mark in an address field to notify only the title of the attached file.

13. The electronic mail composing device according to claim 1, wherein the editing means places a specific mark in a field other than the address field.

14. The electronic mail composing device according to claim 7, wherein the editing unit places a specific mark in a field other than the address field.

15. The electronic mail communication system according to claim 5, wherein the first communication device and the second communication device communicate via the Internet.

16. The electronic mail communication system according to claim 15, wherein the first communication device and the second communication device communicate via a local area network

17. A method for composing electronic mail comprising:
editing an electronic mail by setting either to attach content of at least one attachment file or to notify only a title of the attachment file;
generating the electronic mail with the notified title of the attachment file; and
transmitting the electronic mail attached with the content of the attachment file or the electronic mail with the notified title.

18. The method according to claim 17 further comprising:
accepting the setting whether to attach the content for each attachment file or whether to notify only the title of the attachment file for each attachment file; and
generating the electronic mail with the notified title.

19. The method according to claim 17 further comprising:
setting a destination for which to attach the attachment file and a destination for which to be notified only with the title of the attachment file; and
transmitting according to the destination, the electronic mail attached with the attachment file or the electronic mail generated.

20. The method according to claim 18 further comprising:
accepting the setting whether to attach the content for each attachment file or whether to notify only the title of the attachment file for each attachment file; and
generating the electronic mail with the notified title.
